(19) United States
(12) Patent Application Publication
(10) Pub. No.: US 2013/0294233 A1
(43) Pub. Date: Nov. 7, 2013

(54) BASE STATION CONTROL METHOD FOR CONNECTION OF TERMINAL WITH HIGHER PRIORITY AND BASE STATION SUPPORTING THE SAME

(71) Applicants: ELECTRONICS AND TELECOMMUNICATIONS RESEARCH INSTITUTE, (US); Industry-Academic Cooperation Foundation, Chosun University, (US)

(72) Inventors: Won-Ik Kim, Daejeon (KR); Seokki Kim, Gyeonggi-do (KR); Sung Kyung Kim, Daejeon (KR); Mi Young Yun, Daejeon (KR); Hyun Lee, Daejeon (KR); Chul Sik Yoon, Daejeon (KR); Sung Cheol Chang, Daejeon (KR); Seokjoo Shin, Gwangju (KR)

(73) Assignees: Industry-Academic Cooperation Foundation, Chosun University, Gwangju (KR); ELECTRONICS AND TELECOMMUNICATIONS RESEARCH INSTITUTE, Daejeon (KR)

(21) Appl. No.: 13/886,635

(22) Filed: May 3, 2013

(30) Foreign Application Priority Data
May 4, 2012 (KR) 10-2012-0047415
Apr. 26, 2013 (KR) 10-2013-0046842

(51) Int. Cl. H04W 28/04

(52) U.S. Cl. CPC H04W 28/044
USPC 370/230

(57) ABSTRACT

A method of controlling a base station is disclosed that provides service to a first terminal and a second terminal having higher priority than the first terminal. The base station determines whether there is an influx of call connection attempts when the lower-priority terminal and the higher-priority terminal perform ranging. If it is determined that there is an influx of call connection attempts, the base station sets the initial ranging backoff window size included in an information element of S-SFH SP3 (Secondary-Superframe Header SubPacket3) to a first size. If it is determined that there is an influx of call connection attempts, the base station sets the initial ranging backoff window size for the second terminal in an AAI-SCD (Advanced Air Interface-System Configuration Descriptor) message to a second size. Accordingly, it is possible to achieve a high probability of success of initial ranging of a higher-priority terminal.

### CROSS-REFERENCE TO RELATED APPLICATION

This application claims priority to and the benefit of Korean Patent Application Nos. 10-2012-0047415, and 10-2003-0046842 filed in the Korean Intellectual Property Office on May 4, 2012, and Apr. 26, 2013, respectively, the entire contents of which are incorporated herein by reference.

### BACKGROUND OF THE INVENTION

(a) Field of the Invention

The present invention relates to a base station control method for connection of a higher-priority terminal and a base station supporting the same.

(b) Description of the Related Art

There are cases where a number of terminals may simultaneously attempt to make an initial call connection to a base station in a wireless communication system environment. Such an influx of call connection attempts often occurs in areas stricken by major disasters and emergencies.

If a situation occurs that requires initial call connection, multiple terminals attempt to make a connection to a base station through limited resources. In such an initial ranging process or random access process, if multiple terminals select the same ranging preamble code for initial ranging and use the same wireless resources for initial ranging, the multiple terminals may collide with each other, and the initial call connection has a high probability of failure.

In the 4th generation wireless communication standards such as IEEE 802.16m, a cell bar bit (=1 bit) is defined for an Information Element of S-SFH (Secondary Superframe Header) SP3 (SubPacket3) transmitted from the base station. In the event of an influx of call connection attempts, the base station may set to 1. If the cell bar bit set to 1 is transmitted, all the call connections from users may be cut off.

However, if terminals have different priorities in a wireless communication system environment, methods and procedures need to be put in place to make the initial ranging of higher-priority terminals successful faster than the initial ranging of lower-priority terminals.

### SUMMARY OF THE INVENTION

The present invention has been made in an effort to provide a method and procedure for achieving a high probability of success of initial ranging of a higher-priority terminal.

An exemplary embodiment of the present invention provides a method of controlling a base station that provides service to a first terminal and a second terminal having higher priority than the first terminal. The base station control method may include: determining whether there is an influx of call connection attempts when the first terminal and the second terminal perform initial ranging; if it is determined that there is an influx of call connection attempts, setting a initial ranging backoff window size included in an information element of S-SFH SP3 (Secondary-Superframe Header SubPacket3) to a first size; and if it is determined that there is an influx of call connection attempts, setting a initial ranging backoff window size for the second terminal in an AAI-SCD (Advanced Air Interface-System Configuration Descriptor) message to a second size.

The second size may be smaller than the first size.

The base station control method may further include: transmitting the S-SFH SP3 to the first terminal and the second terminal; and transmitting the AAI-SCD message to the first terminal and the second terminal. The base station control method may further include: making an initial ranging attempt with the initial ranging backoff window size set to the first size by the first terminal; and making an initial ranging attempt with the initial ranging backoff window size set to the second size by the second terminal.

The determining may include: detecting a random preamble code; granting resources to enable the first terminal and the second terminal to transmit an AAI-RNG-REQ (Advanced Air Interface-Ranging-Request) message, and transmitting ACK to the first terminal and the second terminal; and after transmitting the ACK to the first terminal and the second terminal, detecting a failure of reception of the AAI-RNG-REQ message. The determining may further include:

counting the frequency of random preamble code detection, ACK transmission, and AAI-RNG-REQ message reception failure detection; and if the frequency count exceeds a predetermined reference count, determining that there is an influx of initial call connection attempts.

The determining may include, if the numbers of random preamble codes and random access channels used for initial ranging are higher than the average numbers for normal mode, determining that there is an influx of initial call connection attempts.

The initial ranging backoff window size may be set using initial ranging backoff start and initial ranging backoff end.

Another exemplary embodiment of the present invention provides a base station. The base station may include: a radio frequency module; and a processor connected with the radio frequency module, and providing service to a first terminal and a second terminal having higher priority than the first terminal, wherein if it is determined that there is an influx of call connection attempts when the first terminal and the second terminal perform initial ranging the processor sets a initial ranging backoff window size included in an information element of S-SFH SP3 (Secondary-Superframe Header SubPacket3) to a first size and a initial ranging backoff window size for the second terminal in an AAI-SCD (Advanced Air Interface-System Configuration Descriptor) message to a second size.

The second size may be smaller than the first size.

The first terminal may make an initial ranging attempt with the initial ranging backoff window size set to the first size, and the second terminal may make an initial ranging attempt with the initial ranging backoff window size set to the second size.

Yet another exemplary embodiment of the present invention provides a method in which a second terminal having higher priority than a first terminal, among sub-terminals of a base station, is connected to the base station. The method may include: performing initial ranging with the base station; receiving from the base station an AAI-SCD (Advanced Air Interface-System Configuration Descriptor) message including a first initial ranging backoff window size, which is smaller than a initial ranging backoff window size for the first terminal; and performing initial ranging again with the base station by using the first initial ranging backoff window size.

The initial ranging backoff window size may be set using initial ranging backoff start and initial ranging backoff end.

The second terminal may be connected to the base station earlier than the first terminal.

According to an embodiment of the present invention, it is possible to achieve a high probability of success of initial ranging of a higher-priority terminal by setting the initial ranging backoff window size for the higher-priority terminal smaller than that for a lower-priority terminal.

### BRIEF DESCRIPTION OF THE DRAWINGS

FIG. 1 is a view showing a wireless communication system in accordance with an exemplary embodiment of the present invention.

FIG. 2 is a view showing a method for initial ranging of a higher-priority terminal in a base station in accordance with the exemplary embodiment of the present invention.

FIG. 3 is a view showing an example where the base station determines whether there is an influx of initial call connection attempts.

FIG. 4 is a view showing another example where the base station determines whether there is an influx of initial call connection attempts.

FIG. 5 is a view showing the base station in accordance with the exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, the term “terminal” may designate a mobile terminal (MT), a mobile station (MS), an advanced mobile station (AMS), a high reliability mobile station (HR-MS), a subscriber station (SS), a portable subscriber station (PSS), an access terminal (AT), user equipment (UE), and so on, or may include all or some functions of the terminal, the MT, the MS, the AMS, the HR-MS, the SS, the PSS, the AT, the UE.

Further, the term “base station (BS)” may designate an advanced base station (ABS), a high reliability base station (HR-BS), a node B, an evolved node B (eNodeB), an access point (AP), a radio access station (RAS), a base transceiver station (BTS), a mobile multihop relay (MMR-BS), a relay station (RS) serving as a base station, and a high reliability relay station (HR-RS) serving as a base station, and may include all or some functions of the ABS, the nodeB, the eNodeB, the AP, the RAS, the BTS, the MMR-BS, the RS, and the HR-RS.

Now, a base station control method for connection of a high-priority terminal and a base station supporting the same in accordance with an exemplary embodiment of the present invention will be described in full detail.

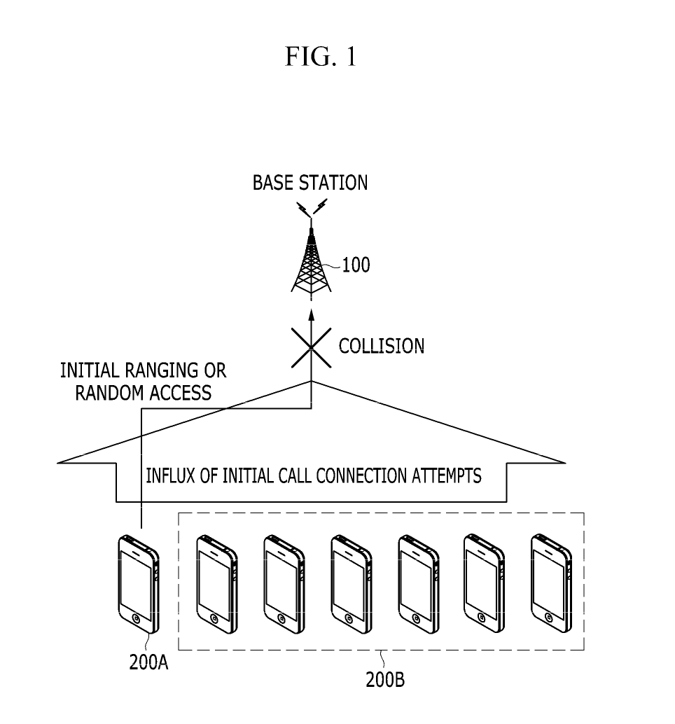

FIG. 1 is a view showing a wireless communication system in accordance with an exemplary embodiment of the present invention.

As shown in FIG. 1, a wireless communication system in accordance with an exemplary embodiment of the present invention includes a base station 100 and multiple sub-terminals 200A and 200B.

The base station 100 offers communication service to the multiple sub-terminals 200A and 200B. When the multiple sub-terminals 200A and 200B simultaneously attempt to make an initial call connection, the base station 100 provides a method and procedure for making the initial ranging for a call connection from the higher-priority terminal 200A faster and more successful than the initial ranging for call connections from the lower-priority terminals 200B. A more detailed description of this method and procedure will be given below with respect to FIG. 1.

The multiple sub-terminals 200A and 200B belong to the base station 100, and are divided into the higher-priority terminal 200A and the lower-priority terminals 200B. The higher-priority terminal 200A and the lower-priority terminals 200B are predefined in preparation for disasters or emergencies. With the higher-priority terminal 200A and the lower-priority terminals 200B mixed up together, an influx of initial call connection attempts occurs in an initial ranging process or random access process, which may cause them to collide with each other. An exemplary embodiment of the present invention provides a method and procedure for achieving a high probability of success of initial ranging of the higher-priority terminal 200A in the event of an influx of initial call connection attempts. In the description to be given below, the initial ranging or random access will be commonly referred to as ‘initial ranging’.

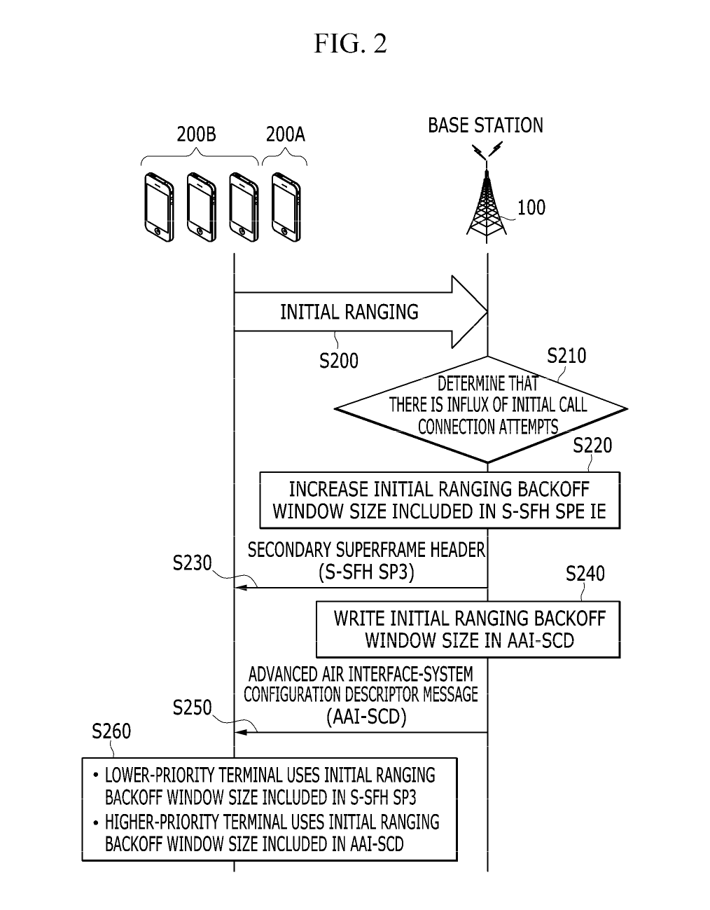

Next, a method and procedure for making the initial ranging for a call connection from the higher-priority terminal 200A faster and more successful than the initial ranging for call connections from the lower-priority terminals 200B in the wireless communication system environment of FIG. 1 where the terminals have different priorities will be described in detail with reference to FIG. 2. That is, a detailed description will be made with respect to the method for achieving a high probability of success of initial ranging of the higher-priority terminal 200A, when the terminals with different priorities are mixed up together within a single base station.

FIG. 2 is a view showing a method for a higher-priority terminal to perform initial ranging with a base station in accordance with the exemplary embodiment of the present invention.

First, the higher-priority terminal 200A and the lower-priority terminals 200B perform initial ranging with the base station 100 (S200).

When higher-priority terminal 200A and the lower-priority terminals 200B perform initial ranging with the base station 100, the base station 100 determines whether there is an influx of initial call connection attempts (S210).

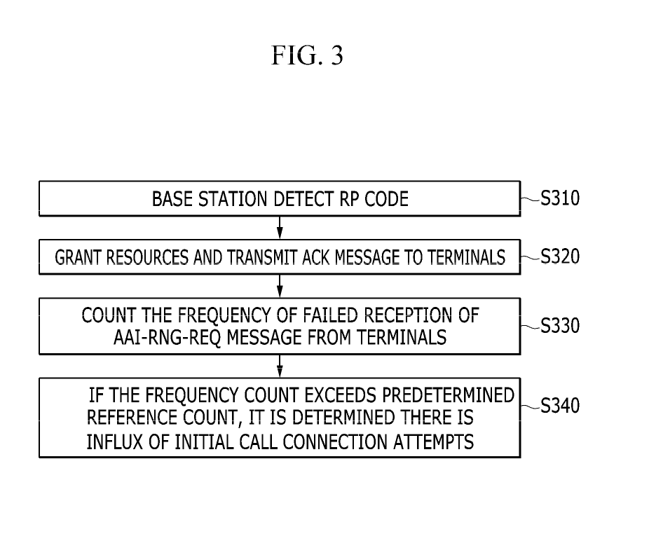

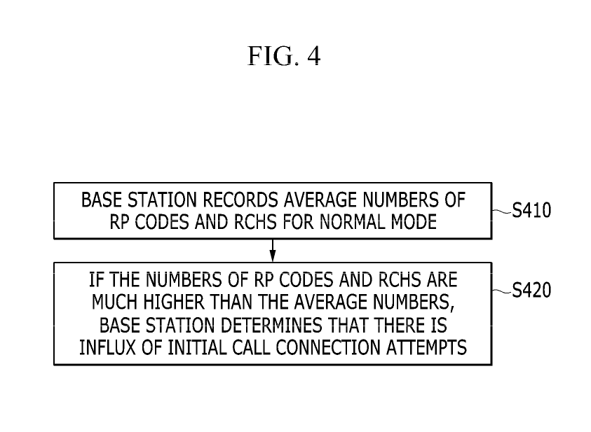

There are the following two methods by which the base station 100 determines whether there is an influx of initial call connection attempts. FIG. 3 is a view showing an example where the base station 100 determines whether there is an influx of initial call connection attempts. FIG. 4 is a view showing another example where the base station 100 determines whether there is an influx of initial call connection attempts.

First, a method for the base station 100 to determine whether there is an influx of initial call connection attempts will be described with reference to FIG. 3.

The base station 100 detects a Random Preamble Code (hereinafter, referred to as ‘RP code’) when the multiple terminals 200A and 200B perform initial ranging (S310). Although a collision occurs when the multiple terminals (i.e., the higher-priority terminal 200A and the lower-priority terminals 200B) transmit a PR code to the base station 100 through the same code and the same Random Access Channel (hereinafter, referred to as ‘RCH’), the base station 100 can detect the RP code by adding a sufficiently long cyclic prefix (CP) to the RP code and repeating the RP code.

Having detected the RP code, the base station 100 grants resources to enable the multiple terminals 200A and 200B to transmit an AAI-RNG-REQ (Advanced Air Interface-Ranging-Request) message, and then transmits an ACK (acknowledge) message to the multiple terminals 200A and 200B (S320).

Upon receiving the ACK message, the multiple terminals 200A and 200B will transmit an AAI-RNG-REQ message through the same resources. However, the base station 100 cannot detect this AAI-RNG-REQ message due to collision. The base station 100 may assume that this is a collision between the multiple terminals 200A and 200B (i.e., flood of initial call connection attempts).

Accordingly, the base station 100 counts the frequency with which it fails to receive an AAI-RNG-REQ message from the multiple terminals 200A and 200 (S330). That is, the base station 100 counts the frequency of the step S310, the step S320, and the step in which the base station 100 fails to receive an AAI-RNG-REQ message.

If the frequency count exceeds a predetermined reference count, the base station 100 determines that there is an influx of initial call connection attempts (S340).

Next, another example in which the base station 100 determines that there is an influx of initial call connection attempts will be described with reference to FIG. 4.

The base station 100 records the average numbers of RP codes and RCHs used for initial ranging in normal mode (S410).

If the numbers of RP codes and RCHs used for initial ranging are much higher than the average numbers for normal mode, the base station 100 determines that there is an influx of initial call connection attempts (S420).

Meanwhile, the base station 100 may define the situation shown in FIG. 4 as the first stage of the influx of initial call connection attempts and the situation shown in FIG. 3 as the second stage of the influx of initial call connection attempts. That is, the base station 100 can finally determine that there is an influx of initial call connection attempts if the situation shown in FIG. 3 occurs after the situation show in FIG. 4 has occurred.

Referring again to FIG. 2, the base station 100 determines whether there is an influx of initial call connection attempts (S210), and controls the initial ranging of the higher-priority terminal 200A and the lower-priority terminals 200B.

Upon determining that there is an influx of initial call connection attempts in the step S210, the base station 100 increases the initial ranging backoff window size included in an Information Element of S-SFH SP3 (S220). If the initial ranging backoff window size increases, the RP codes transmitted from the terminals are less likely to collide with each other, but the delay time for the initial ranging procedure is extended. As shown in the following Tables 1 and 2, the initial ranging backoff window size may be set using initial ranging backoff start and initial ranging backoff end.

The base station 100 transmits the S-SFH SP3 including the initial ranging backoff window size to the multiple terminals 200A and 200B (S230).

The base station 100 writes an initial ranging backoff window size dedicated for the higher-priority terminal 200A in an AAI-SCD (Advanced Air Interface-System Configuration Descriptor) message which is periodically broadcast (S240). The initial ranging backoff window size included in the AAI-SCD message is set to be lower than the initial ranging backoff window size included in the S-SFH SP3.

The base station 100 announces an AAI-SCD message including the initial ranging backoff window size dedicated for the higher-priority terminal 200A to the multiple terminals 200A and 200B (S250).

Having received the S-SFH SP3 from the base station 100, the lower-priority terminals 200B use the initial ranging backoff window size included in the S-SFH SP3 on their initial ranging attempt (S260).

Having received an AAI-SCD message from the base station 100, the higher-priority terminal 200A uses the initial ranging backoff window size included in the AAI-SCD message on its initial ranging attempt (S260).

Upon detecting an influx of initial call connection attempts, the base station 100 according to the exemplary embodiment of the present invention increases the initial ranging back off window size for the lower-priority terminals 200B to extend the initial ranging retransmission attempt time of the lower-priority terminals 200b, and decreases the initial ranging backoff window size for the higher-priority terminal 200A, compared to that of the lower-priority terminals 200B, to shorten the initial ranging retransmission attempt time of the higher-priority terminals 200A. By doing so, the higher-priority terminal 200A is prioritized to perform successful initial ranging.

The following Table 1 shows additional fields, i.e., initial ranging backoff window sizes, to be included in an AAI-SCD message according to whether terminals are given priority or not.

As shown in Table 1, the initial ranging backoff window size can be set by initial ranging backoff window start and initial ranging backoff end.

TABLE 1
Additional Fields in AAI-SCD Message

| | Size | | |
|---|---|---|---|
| Field | (bits) | Value/Description | Condition |
| . . . | . . . | . . . | . . . |
| Initial | 4 | Initial backoff window size for initial | Shall be present for |
| ranging | | ranging contention of priority HR-MS, | priority access in |
| backoff | | expressed as a power of 2. Values of n | HR-Network |
| start | | range 0-15 | |
| Initial | 4 | Final backoff window size for initial | Shall be present for |
| ranging | | ranging contention, expressed as a | priority access in |
| backoff | | power of 2. Values of n range 0-15 | HR-Network |
| end | | | |
| . . . | . . . | . . . | . . . |

The following Table 2 shows additional fields to be included in the AAI-SCD message when terminals are given priority and there is a hierarchy of priorities.

TABLE 2
Additional Fields in AAI-SCD Message

| | Size | | |
|---|---|---|---|
| Field | (bits) | Value/Description | Condition |
| . . . | . . . | . . . | . . . |
| For (i = 0; | | N Priority Level is the number of | |
| i < N Priority | | priority level predefined in | |
| Level; i++) { | | HR-Network | |
| Initial ranging | 4 | Initial backoff window size for | Shall be |
| backoff start | | initial ranging contention of | present |
| | | priority HR-MS, expressed as a | for priority |
| | | power of 2. Values of n range 0-15 | access in |
| | | | HR-Network |
| Initial ranging | 4 | Final backoff window size for | Shall be |
| backoff end | | initial ranging contention, | present |
| | | expressed as a power of 2. Values | for priority |
| | | of n range 0-15 | access in |
| | | | HR-Network |
| } | | | |
| . . . | . . . | . . . | . . . |

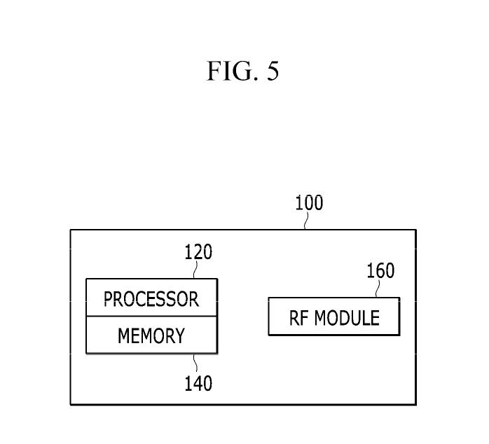

FIG. 5 is a view showing the base station 100 in accordance with the exemplary embodiment of the present invention.

Referring to FIG. 5, the base station 100 includes a processor 120, a memory 140, and a Radio Frequency (RF) module 160. The processor 120 may be configured to implement the procedure and method explained in FIGS. 2 to 4. The memory 140 is connected with the processor 120, and stores various kinds of information related to the operation of the processor 120. The RF module 160 is connected with the processor 220, and transmits or receives a radio signal. The base station 100 may have a single antenna or multiple antennas.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling a base station that provides service to a first terminal and a second terminal having higher priority than the first terminal, the method comprising:
determining whether there is an influx of call connection attempts when the first terminal and the second terminal perform initial ranging;
if it is determined that there is an influx of call connection attempts, setting a initial ranging backoff window size included in an information element of S-SFH SP3 (Secondary-Superframe Header SubPacket3) to a first size; and
if it is determined that there is an influx of call connection attempts, setting a initial ranging backoff window size for the second terminal in an AAI-SCD (Advanced Air Interface-System Configuration Descriptor) message to a second size.

2. The method of claim 1, wherein the second size is smaller than the first size.

3. The method of claim 1, further comprising:
transmitting the S-SFH SP3 to the first terminal and the second terminal; and
transmitting the AAI-SCD message to the first terminal and the second terminal.

4. The method of claim 3, further comprising:
making an initial ranging attempt with the initial ranging backoff window size set to the first size by the first terminal; and
making an initial ranging attempt with the initial ranging backoff window size set to the second size by the second terminal.

5. The method of claim 1, wherein the determining comprises:
detecting a random preamble code;
granting resources to enable the first terminal and the second terminal to transmit an AAI-RNG-REQ (Advanced Air Interface-Ranging-Request) message, and transmitting ACK to the first terminal and the second terminal; and
after transmitting the ACK to the first terminal and the second terminal, detecting a failure of reception of the AAI-RNG-REQ message.

6. The method of claim 5, wherein the determining further comprises:
counting the frequency of random preamble code detection, ACK transmission, and AAI-RNG-REQ message reception failure detection; and
if the frequency count exceeds a predetermined reference count, determining that there is an influx of initial call connection attempts.

7. The method of claim 1, wherein the determining comprises,
if the numbers of random preamble codes and random access channels used for initial ranging are higher than the average numbers for normal mode, determining that there is an influx of initial call connection attempts.

8. The method of claim 1, wherein the initial ranging backoff window size is set using initial ranging backoff start and initial ranging backoff end.

9. A base station comprising:
a radio frequency module; and
a processor connected with the radio frequency module, and providing service to a first terminal and a second terminal having higher priority than the first terminal,
wherein if it is determined that there is an influx of call connection attempts when the first terminal and the second terminal perform initial ranging the processor sets a initial ranging backoff window size included in an information element of S-SFH SP3 (Secondary-Superframe Header SubPacket3) to a first size and a initial ranging backoff window size for the second terminal in an AAI-SCD (Advanced Air Interface-System Configuration Descriptor) message to a second size.

10. The base station of claim 9, wherein the second size is smaller than the first size.

11. The base station of claim 9, wherein the first terminal makes an initial ranging attempt with the initial ranging backoff window size set to the first size, and the second terminal makes an initial ranging attempt with the initial ranging backoff window size set to the second size.

12. A method in which a second terminal having higher priority than a first terminal, among sub-terminals of a base station, is connected to the base station, the method comprising:
performing initial ranging with the base station;
receiving from the base station an AAI-SCD (Advanced Air Interface-System Configuration Descriptor) message including a first initial ranging backoff window size, which is smaller than a initial ranging backoff window size for the first terminal; and
performing initial ranging again with the base station by using the first initial ranging backoff window size.

13. The method of claim 12, wherein the initial ranging backoff window size is set using initial ranging backoff start and initial ranging backoff end.

14. The method of claim 12, wherein the second terminal is connected to the base station earlier than the first terminal.
